(19) United States
(12) Patent Application Publication
(10) Pub. No.: US 2016/0198160 A1
(43) Pub. Date: Jul. 7, 2016

(54) METHOD OF COMPRESSION ENCODING OF AVS VIDEO AND ENCODER

(71) Applicant: PEKING UNIVERSITY SHENZHEN GRADUATE SCHOOL, Shenzhen (CN)

(72) Inventors: Zhenyu WANG, Shenzhen (CN); Ronggang WANG, Shenzhen (CN); Wen GAO, Shenzhen (CN); Wenmin WANG, Shenzhen (CN); Shengfu DONG, Shenzhen (CN); Ying LI, Shenzhen (CN)

(21) Appl. No.: 14/981,838

(22) Filed: Dec. 28, 2015

Related U.S. Application Data
(63) Continuation-in-part of application No. PCT/CN2013/078148, filed on Jun. 27, 2013.

(51) Int. Cl. H04N 19/146; H04N 19/18; H04N 19/176; H04N 19/61; H04N 19/169; H04N 19/119; H04N 19/70; H04N 19/136; H04N 19/126; H04N 19/186

(52) U.S. Cl. CPC H04N 19/146; H04N 19/126; H04N 19/18; H04N 19/176; H04N 19/186; H04N 19/1883; H04N 19/119; H04N 19/70; H04N 19/136; H04N 19/61

(57) ABSTRACT

An AVS video compression encoding method, including: 1) obtaining an image to be encoded; 2) calculating an average luminance value of the image to be encoded; 3) extracting an attribute component from the image to be encoded, dividing the attribute component into a plurality of attribute blocks, obtaining a transformation coefficient of every frequency point in an attribute block, and calculating a first average transformation coefficient of every frequency point in all attribute blocks, and calculating a second average transformation coefficient of a frequency band by first average transformation coefficients of all frequency points in the frequency; and 4) obtaining a final weighted quantization coefficient by using the average luminance value of the image to be encoded and the second average transformation coefficient of every frequency band to correspondingly adjust an initial weighted quantization coefficient of every frequency band in the quantization matrix.

### CROSS-REFERENCE TO RELATED APPLICATIONS

This application is a continuation-in-part of International Patent Application No. PCT/CN2013/078148 with an international filing date of Jun. 27, 2013, designating the United States, now pending. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to a data processing field, in particular to an AVS video compression encoding method and encoder.

2. Description of the Related Art

New generation of Audio Video Coding Standard (AVS) has been widely used. The AVS provides fixed quantization matrices. The frequency bands of the quantization matrices are divided as shown in FIG. 1, having six frequency bands marked 0 to 5. Every frequency band corresponds to one weighted quantization coefficient. However, using the fixed quantization matrices for quantization processing cannot completely remove visual redundancy. As a result, the encoding rate of Audio Video cannot be lowered effectively.

### SUMMARY OF THE INVENTION

In view of the above described problems, the invention provides an AVS video compression encoding method and encoder to effectively reduce the code rate while guarantee quality of video encoding.

According to the first aspect of the invention, the invention provides an AVS video compression encoding method comprising:
obtaining an image to be encoded;
calculating the average luminance value of the image to be encoded by the pixel luminance value of every pixel of the image to be encoded;
dividing the image to be encoded into a plurality of blocks, and transforming the blocks to obtain the transformation coefficient of every frequency point so as to calculate a first average transformation coefficient of every frequency point in all blocks to which the frequency point belongs by transformation coefficients of frequency points; and calculating a second average transformation coefficient of the frequency band by the first average transformation coefficients of all frequency points in the frequency band on the basis of initial frequency band division of the quantization matrix; and
using the average luminance value of the image to be encoded and the second average transformation coefficient of every frequency band to correspondingly adjust the initial weighted quantization coefficient of every frequency band in the quantization matrix to obtain the final weighted quantization coefficient.

According to the second aspect of the invention, the invention provides an AVS video encoder comprising:
a module for obtaining an image to be encoded;
a luminance value calculation module for calculating the average luminance value of the image to be encoded by the first luminance value of every pixel in the image to be encoded;
a division module for dividing the image to be encoded into a plurality of blocks;
a transformation module for transforming the blocks to obtain the transformation coefficient of every frequency point in the block, an average transformation coefficient calculation module for calculating a first average transformation coefficient of every frequency point in all blocks to which the frequency point belongs by transformation coefficients of frequency points and calculating a second average transformation efficient of the frequency band by the first average transformation coefficients of all frequency points in the frequency band on the basis of initial frequency band division of the quantization matrix; and
an adjustment module for using the average luminance value of the image to be encoded and the second average transformation coefficient of every frequency band to correspondently adjust the initial weighted quantization coefficient of every frequency band in the quantization matrix to obtain the final weighted quantization coefficient.

The invention has the following advantageous effects:

The invention provides an AVS video compression encoding method and encoder which mainly adjusts the initial weighted quantization coefficient of every frequency band in a quantization matrix by using the average luminance value of an image to be encoded and average transformation coefficient of every frequency band obtained by calculation to obtain a final weighted quantization coefficient for quantization so as to be able to perform different step-size quantization on transformation coefficients of different frequency points obtained by transformation by using a quantization matrix constituted by final weighted quantization coefficients. Therefore, the process of quantization can fully take attributes of an image to be encoded into account, self-adaptively adjust weighted quantization coefficients in a quantization matrix and effectively lower the code rate while guaranteeing video encoding quality.

### BRIEF DESCRIPTION OF THE DRAWINGS

FIG. 1 is a diagram of frequency band division in a quantization matrix in prior art;

FIG. 2 is a flow diagram of an AVS video compression encoding method in Example 1 of the invention;

FIG. 3 is a specific flow diagram of the Step 202 in Example 1 of the invention;

FIG. 4 is a diagram of initial weighted quantization coefficients in a quantization matrix in Example 1 of the invention;

FIG. 5 is a structural diagram of an AVS video encoder in Example 1 of the invention;

FIG. 6 is a structural diagram of a luminance value calculation unit 502 in Example 1 of the invention;

FIG. 7 is a structural diagram of an adjustment module 506 in Example 1 of the invention;

FIG. 8 is a specific flow diagram of the Step 202 in Example 2 of the invention;

FIG. 9 is a structural diagram of a luminance value calculation unit 502 in Example 2 of the invention;

FIG. 10 is a specific flow diagram of the Step 204 in Example 3 of the invention; and

FIG. 11 is a structural diagram of an adjustment module 506 in Example 3 of the invention.

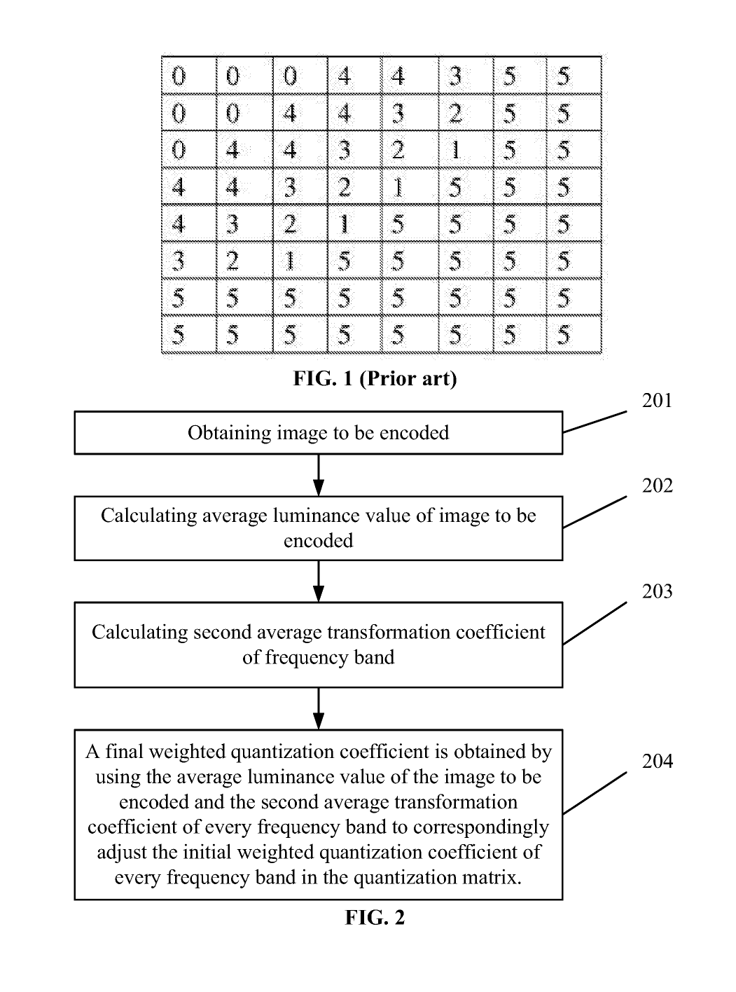

### DETAILED DESCRIPTION OF THE EMBODIMENTS

The invention is further explained in detail by embodiments and figures as below.

### EXAMPLE 1

An AVS video compression encoding method in the embodiment mainly comprises: firstly, making an intra-frame or inter-frame prediction about an image to be encoded to obtain residual blocks; and secondly, obtaining the code rate by transformation and quantization of residual blocks and entropy encoding; in which, final weighted quantization coefficients in the embodiment are mainly used during the quantization process and final weighted quantization coefficients are obtained as shown in FIG. 2:

Step 201: an image to be encoded is obtained.

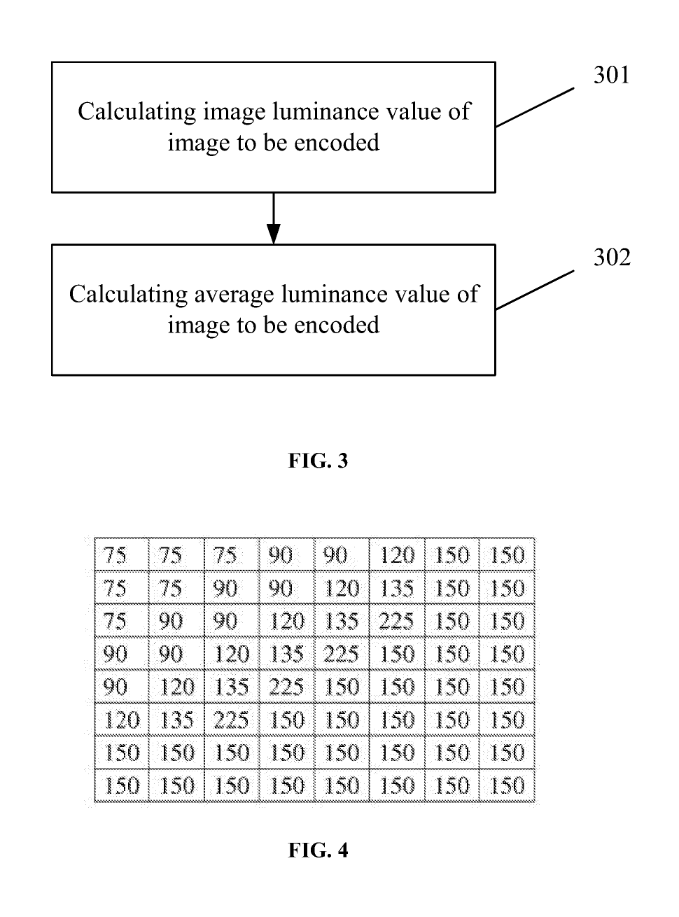

Step 202: the average luminance value of the image to be encoded is calculated by the pixel luminance value of every pixel in the image to be encoded. In particular, the Step 202 can comprise steps shown in FIG. 3:

Step 301: the image luminance value L of the image to be encoded is calculated by the pixel luminance value l(m) of every pixel in the image to be encoded, in which, the image to be encoded comprises M pixels, m∈{1, 2, . . . , M}. Then, the image luminance value of the image to be encoded can be calculated by the following Formula (1):

L=Σₘ₌₁^{M}l(m) (1).

Step 302: the average luminance value L̅ of the image to be encoded is calculated by the image luminance value L and pixel number M of the image to be encoded. The average luminance value L̅ of the image to be encoded can be calculated by the following Formula (2):

$$\overline{L} = \frac{L}{M} . \qquad ( 2 )$$

Step 203: an attribute component is extracted from the image to be encoded, the attribute component is divided into a plurality of attribute blocks, the transformation coefficient of every frequency point in the attribute block is obtained by transformation of the attribute block, and a first average transformation coefficient of every frequency point in all attribute blocks to which the frequency point belongs is calculated by the transformation coefficient of the frequency point; and a second average transformation coefficient of the frequency band is calculated by the first average transformation coefficients of all frequency points in the frequency band on the basis of initial frequency band division in the quantization matrix. In particular, a luminance component can be extracted from the image to be encoded; the luminance component is divided into a plurality of luminance blocks; the luminance transformation coefficient of each frequency point in the luminance block is obtained by transformation of the luminance block; the average luminance transformation coefficient of every frequency point in all luminance blocks to which the frequency point belongs is calculated as a first average transformation coefficient by the luminance transformation coefficient of the frequency point; the Discrete Cosine Transform (DCT), approximate DCT or orthogonal transformation can be used for transformation; and the luminance transformation coefficient of each frequency point can be represented as C_{y}(k,i,j), in which, the luminance component of the image to be encoded is divided into K luminance blocks, k∈{1, 2, . . . , K}; K is a positive integer; the size of a luminance block generally is a specification of 8×8 pixels; i and j represent the location of a frequency point in the luminance block; and then, the average luminance transformation coefficient C̅(i, j) of every frequency point in all luminance blocks to which the frequency point belongs is also a first average transformation coefficient C̅(i,j) which can be calculated by the following Formulas (3) and (4):

$$\begin{matrix}C ( i , j ) = {\sum }_{k = 1}^{K} {C}_{y} ( k , i , j ) , & ( 3 ) \\ \overline{C} ( i , j ) = \frac{C ( i , j )}{K} . & ( 4 )\end{matrix}$$

The second average transformation coefficient C(q) of the frequency band can be calculated by the following Formula (5):

C(q)=Σ_{(i,j)∈S(q)}C̅(i,j) (5),

in which, S(q) represents the frequency point contained in the q^{th} frequency band.

Step 204: a final weighted quantization coefficient is obtained by using the average luminance value of the image to be encoded and the second average transformation coefficient of every frequency band to correspondingly adjust the initial weighted quantization coefficient of every frequency band in the quantization matrix. In particular, the initial frequency band division of the quantization matrix is to divide the whole frequency domain into 6 frequency bands whose initial weighted quantization coefficients are {w₁, w₂, w₃, w₄, w₅, w₆}, in which, w_{q} is the initial weighted quantization coefficient of the q^{th} frequency band, q∈{1, 2, 3, 4, 5, 6}, w₁<w₅<w₄<w₃<w₆<w₂. As shown in FIG. 4, the preferred initial weighted quantization coefficients of the 6 frequency bands are {75, 225, 135, 120, 90, 150}. In the embodiment, a final weighted quantization coefficient can be obtained by finding the product of the average luminance value of the image to be encoded, a second average transformation coefficient of every frequency band and an initial weighted quantization coefficient of every frequency band. The final weighted quantization coefficient WB(q) is obtained by the following Formula (6):

WB(q)=w_{q}×L̅×C(q) (6).

After the final weighted quantization coefficient is obtained, the code rate can finally be obtained by the intra-frame or inter-frame prediction or transformation and the quantization and entropy encoding of the final weighted quantization coefficient.

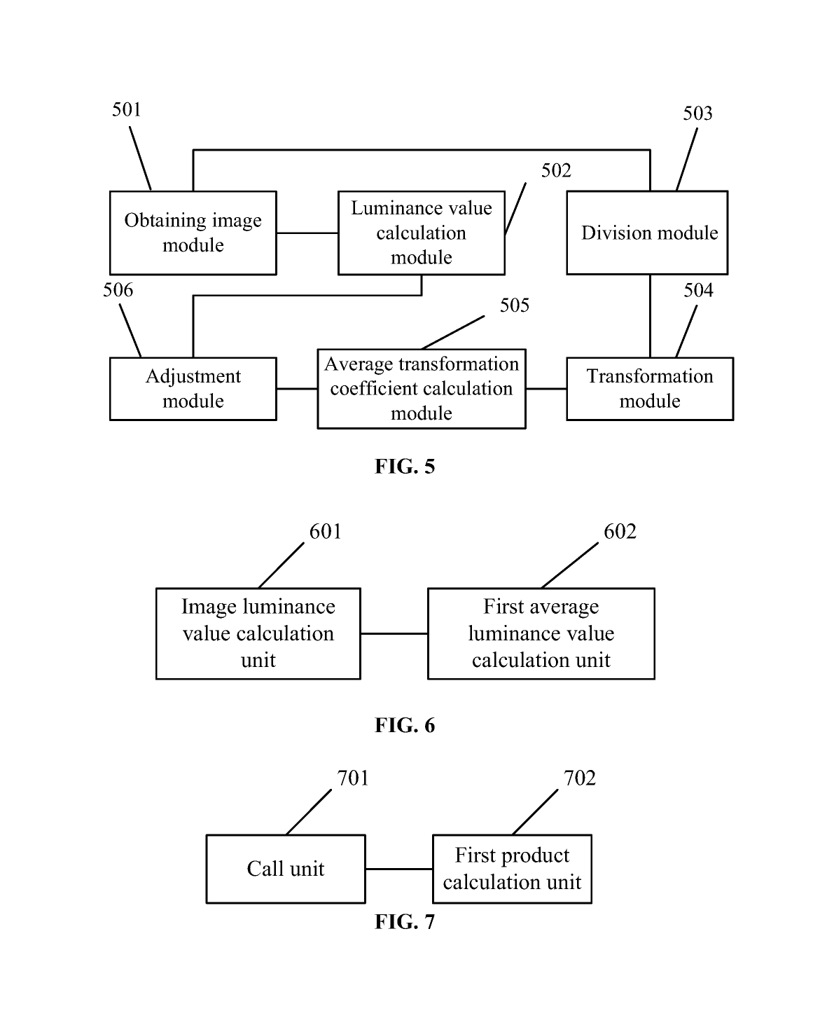

Accordingly, an AVS video encoder in the embodiment can comprise a structure as shown in FIG. 5. It is understood that the AVS video encoder can also comprise modules correspondingly for intra-frame or inter-frame prediction, transformation and entropy encoding.
The module 501 is used for obtaining an image to be encoded;
The luminance value calculation module 502 is used for calculating the average luminance value of the image to be encoded by the first luminance value of every pixel of the image to be encoded;

The division module 503 is used for extracting an attribute component from the image to be encoded and dividing the attribute component into a plurality of attribute blocks;
The transformation module 504 is used for transforming the attribute blocks to obtain the transformation coefficient of every frequency point in the attribute block;
The average transformation coefficient calculation module 505 is used for calculating a first average transformation coefficient of every frequency point in all attribute blocks to which the frequency point belongs by transformation coefficients of frequency points, and calculating a second average transformation efficient of the frequency band by the first average transformation coefficients of all frequency points in the frequency band on the basis of initial frequency band division of the quantization matrix. The initial frequency band division is to divide the whole frequency domain into 6 frequency bands whose initial weighted quantization coefficients are {w₁, w₂, w₃, w₄, w₅, w₆}, in which, w_{q} is the initial weighted quantization coefficient of the q^{th} frequency band, q∈{1, 2, 3, 4, 5, 6}, w₁<w₅<w₄<w₃<w₆<w₂. The preferred values for the initial weighted quantization coefficients of the 6 frequency bands are {75, 225, 135, 120, 90, 150}.

The attribute component is a luminance component; and the attribute block is a luminance block. The transformation module 504 can be used for transforming a luminance block to obtain the luminance transformation coefficient of each frequency point in the luminance block. The average transformation coefficient calculation module 505 can be used for calculating the average luminance transformation coefficient of every frequency point in all luminance blocks to which the frequency point belongs as a first average transformation coefficient by the luminance transformation coefficient of the frequency point.

The adjustment module 506 is used for using the average luminance value of the image to be encoded and the second average transformation coefficient of every frequency band to correspondingly adjust the initial weighted quantization coefficient of every frequency band in the quantization matrix to obtain the final weighted quantization coefficient, in which, the luminance value calculation model 502 comprises the structure shown in FIG. 6:
the image luminance value calculation unit 601 is used for calculating the image luminance value of an image to be encoded by the pixel luminance value of every pixel in the image to be encoded; and
the first average luminance value calculation unit 602 is used for calculating the average luminance value of an image to be encoded by the image luminance value and pixel number of the image to be encoded.

The adjustment module 506 comprises the structure shown in FIG. 7:
the call unit 701 is used for obtaining an initial weighted quantization coefficient of every frequency band in a quantization matrix; and
the first product calculation unit 702 is used for finding the product of the average luminance value of the image to be encoded, a second average transformation coefficient of every frequency band and an initial weighted quantization coefficient of every frequency band to obtain a final weighted quantization coefficient.

The embodiment provides an AVS video compression encoding method and encoder which mainly adjusts the initial weighted quantization coefficient of every frequency band in a quantization matrix by using the average luminance value of an image to be encoded and average transformation coefficient of every frequency band obtained by calculation to obtain a final weighted quantization coefficient for quantization so as to be able to perform different step-size quantization on transformation coefficients of different frequency points obtained by transformation by using a quantization matrix constituted by final weighted quantization coefficients. Therefore, the process of quantization can fully take attributes of an image to be encoded such as luminance and chrominance into account, self-adaptively adjust weighted quantization coefficients in a quantization matrix and effectively lower the code rate while guaranteeing video encoding quality. In addition, since initial weighted quantization coefficients which comply with visual characteristics of human beings are used, the initial weighted quantization coefficients of the 6 frequency bands in the quantization matrix are {w₁, w₂, w₃, w₄, w₅, w₆}, in which, w_{q} is the q^{th} initial weighted quantization coefficient of the frequency band, q∈{1, 2, 3, 4, 5, 6}, w₁<w₅<w₄<w₃<w₆<w₂; and the preferred initial weighted quantization coefficients of the 6 frequency bands are {75, 225, 135, 120, 90, 150}. Thus the video compression encoding can further remove visual redundancy of the video sequence and further lower the code rate effectively while guaranteeing video encoding quality.

### Example 2

The main differences between Example 2 and Example 1 are that:

In the AVS video compression encoding method, the Step 202 can be realized by the flow shown in FIG. 8, in which the block division method in the Step 203 can be used:

in the Step 801, after an image to be encoded is divided into a plurality of blocks, the block luminance value of every block is calculated by pixel luminance values of all pixels in every block. In particular, the block luminance value can be calculated by the following Formula (7):

B(k)=Σₘ₌₁^{N}l(m) (7),

in which, l(m) represents the pixel luminance value of the m^{th} pixel in the k^{th} block, m∈{1, 2, . . . , N}, and N represents the number of pixels in the k^{th} block.

In the Step 802, the average luminance value of the image to be encoded can be calculated by block luminance values of all blocks and the number of blocks. In particular, the average luminance value L of the image to be encoded can be calculated by the following Formula (8):

$$\overline{L} = \frac{{\sum }_{k = 1}^{K} B ( k )}{K} . \qquad ( 8 )$$

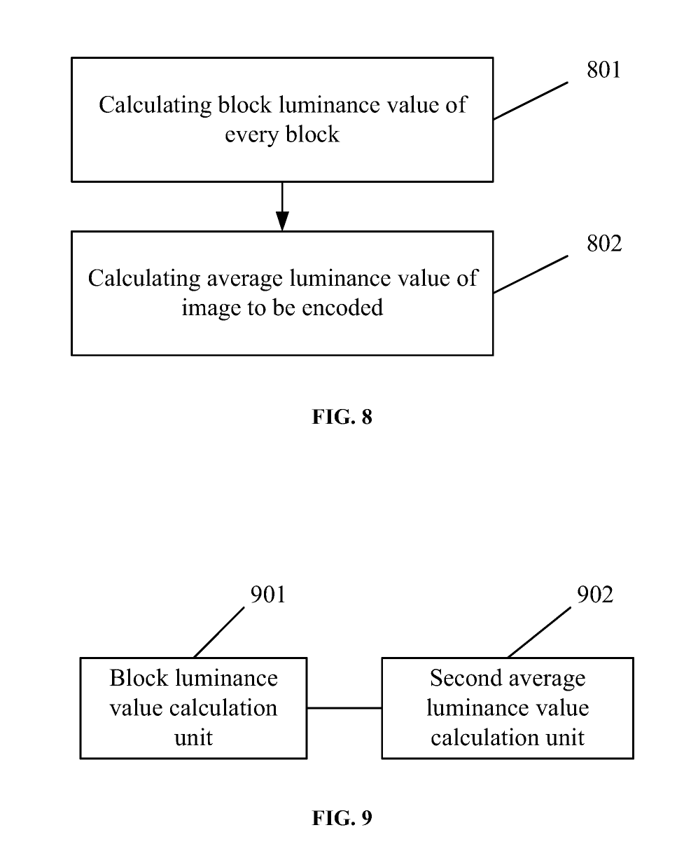

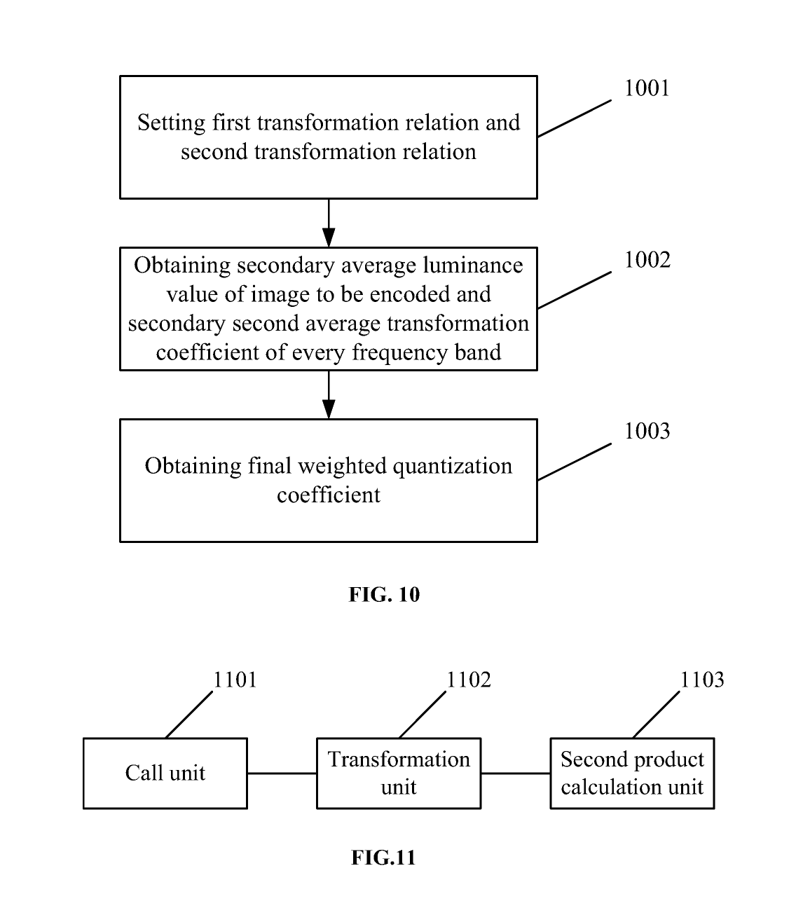

According, the luminance value calculation module 502 can be replaced with the structure shown in FIG. 9:
the block luminance value calculation unit 901 is used for calculating the block luminance value of every block by pixel luminance values of all pixels in every block after the division module 503 divides the image to be encoded into a plurality of blocks; and
the second average luminance value calculation unit 902 is used for calculating the average luminance value of the image to be encoded by the block luminance values of all blocks and the number of blocks.

### EXAMPLE 3

The main differences between Example 3 and Example 1 or Example 2 are that:

In the AVS video compression encoding method, the Step 204 can be realized by the flow shown in FIG. 10:

The Step 1001 sets the first transformation relation for representing the influence degree that the average luminance value of the image to be encoded has on the weighted quantization coefficient in the quantization matrix, and the second transformation relation for representing the influence degree that the second average transformation coefficient of every frequency band has on the weighted quantization coefficient in the quantization matrix. In particular, the first transformation relation can be as the following Formula (9):

$$\overline{{L}^{′}} = \frac{1 + a \overline{L}}{b} , \qquad ( 9 )$$

in which, L̅′̅ represents the secondary average luminance value of the subsequent image to be encoded; and a and b are all settable constants. The influence degree of the average luminance value of the image to be encoded on the weighted quantization coefficient in the quantization matrix can be adjusted by adjusting the constants a and b.

The second transformation relation can be as the following Formula (10):

$${C}^{′} ( q ) = \frac{1 + e \times C ( q )}{f} , \qquad ( 10 )$$

in which, C′ (q) represents the secondary second average transformation coefficient of every subsequent frequency band; and both e and f are settable constants. That is, the influence degree of the second average transformation coefficient of every frequency band on the weighted quantization coefficient in the quantization matrix can be adjusted by adjusting the constants e and f.

The Step 1002 transforms the average luminance value of the image to be encoded by using the first transformation relation to obtain the secondary average luminance value of the image to be encoded, and transforms the second average transformation coefficient of every frequency band by using the second transformation relation to obtain the secondary second average transformation coefficient of every frequency band. In particular, the Formulas (9) and (10) can be used to obtain the secondary average luminance value L̅′̅ of the image to be encoded and the secondary second average transformation coefficient C′(q) of every frequency band.

The Step 1003 finds the product of the secondary average luminance value of the image to be encoded, the secondary second average transformation coefficient of every frequency band and the initial weighted quantization coefficient of every frequency band to obtain the final weighted quantization coefficient. In particular, the final weighted quantization coefficient WB(q) of the q^{th} frequency band can be calculated by the following Formula (11):

WB(q)=w_{q}×L̅′̅C′(q) (11).

Accordingly, the adjustment module 506 can be replaced with the structure shown in FIG. 11:
the call unit 1101 is used for obtaining an initial weighted quantization coefficient of every frequency band in a quantization matrix;
the transformation unit 1102 is used for transforming the average luminance value of the image to be encoded by using the first transformation relation to obtain the secondary average luminance value of the image to be encoded, and for transforming the second average transformation coefficient of every frequency band by using the second transformation relation to obtain the secondary second average transformation coefficient of every frequency band, according to the preset first transformation relation used for representing the influence degree that the average luminance value of the image to be encoded has on the weighted quantization coefficient in the quantization matrix, and the preset second transformation relation used for representing the influence degree that the second average transformation coefficient of every frequency band has on the weighted quantization coefficient in the quantization matrix; and
the second product calculation unit 1103 is used for finding the product of the secondary average luminance value of the image to be encoded, the secondary second average transformation coefficient of every frequency band and the initial weighted quantization coefficient of every frequency band to obtain the final weighted quantization coefficient.

### EXAMPLE 4

The main differences between Example 4 and any one of the Examples 1, 2 and 3 are that:

In the Step 203 of the AVS Video compression encoding method, an attribute component is extracted from the image to be encoded, the attribute component is divided into a plurality of attribute blocks, the transformation coefficient of every frequency point in the attribute block is obtained by transformation of the attribute block. And the calculation of a first average transformation coefficient of every frequency point in all attribute blocks to which the frequency point belongs by the transformation coefficient of the frequency point can also be realized as follows: the luminance component and the chrominance component can be extracted from the image to be encoded; the luminance component is divided into a plurality of luminance blocks; the chrominance component is divided into a plurality of chrominance blocks; the luminance transformation coefficient of each frequency point in the luminance block is obtained by transformation of the luminance block; the chrominance transformation coefficient of each frequency point in the chrominance block is obtained by transformation of the chrominance block; the average combined transformation coefficient of every frequency point in all luminance blocks and chrominance blocks to which the frequency point belongs is calculated as a first average transformation coefficient by the luminance transformation coefficient and the chrominance transformation coefficient of the frequency point. In particular, the Discrete Cosine Transform (DCT), approximate DCT or orthogonal transformation can be used for transformation; and the luminance transformation coefficient of each frequency point can be represented as C_{y}(k,i,j). Since the chrominance comprises two categories Cr and Cb, the chrominance component correspondingly comprises the chrominance component Cr and the chrominance component Cb, and the chrominance transformation coefficient correspondingly comprises two sub-chrominance transformation coefficients Cᵥ(k, i,j) and Cᵤ(k, i,j), in which, the luminance component of the image to be encoded is divided into K luminance blocks, k∈{1, 2, . . . , K}; K is a positive integer; the chrominance component of the image to be encoded is divided into G chrominance blocks Cr and G chrominance blocks Cb, g∈{1, 2, . . . , G}; G is a positive integer and usually one fourth of K; the size of the luminance block, the chrominance blocks Cr and Cb are usually 8×8 pixels; i and j represent the locations of a frequency point in the luminance block and the chrominance blocks Cr and Cb; then, the average combined transformation coefficient C(i,j) of every frequency point in all luminance blocks and the chrominance blocks Cr and Cb to which the frequency point belongs is also a first average transformation coefficient C̅(i, j) which can be calculated by the following Formulas (12):

$$\overline{C} ( i , j ) = \frac{{\sum }_{k = 1}^{K} {C}_{y} ( k , i , j ) + {\sum }_{g = 1}^{G} {C}_{v} ( g , i , j ) + {\sum }_{g = 1}^{G} {C}_{u} ( g , i , j )}{K + G + G} . \qquad ( 12 )$$

Accordingly, in the AVS video encoder of the embodiment, the attribute components comprise luminance component and chrominance component; and the attribute blocks comprise luminance blocks and chrominance blocks. The transformation module 504 can be used to obtain the luminance transformation coefficient of each frequency point in the luminance block by transformation of the luminance block and to obtain the chrominance transformation coefficient of each frequency point in the chrominance block by transformation of the chrominance block. The average transformation coefficient calculation module 505 can be used to calculate the average combined transformation coefficient of every frequency point in all luminance blocks and chrominance blocks to which the frequency point belongs as a first average transformation coefficient by the luminance transformation coefficient and the chrominance transformation coefficient of the frequency point.

The following points need to be further explained:

1. The initial weighted quantization coefficients of the 6 frequency bands can also choose other numerical values. For example, the initial weighted quantization coefficients of the 6 frequency bands can be {70, 220, 135, 115, 85, 140} or {80, 220, 140, 125, 90, 155}.

2. In the embodiments, the blocks are usually macro blocks.

The above content further explains the invention in detail with embodiments. The embodiments of the invention are not limited to these explanations. On the premise of adhering to the inventive concept of the invention, those skilled in the art can also make a plurality of simple deductions and replacements.

The invention claimed is:

1. An AVS video compression encoding method, comprising:
1) obtaining an image to be encoded;
2) calculating an average luminance value of the image to be encoded by a pixel luminance value of every pixel in the image to be encoded;
3) extracting an attribute component from the image to be encoded, dividing the attribute component into a plurality of attribute blocks, obtaining a transformation coefficient of every frequency point in an attribute block by transformation of the attribute block, and calculating a first average transformation coefficient of every frequency point in all attribute blocks to which the frequency point belongs by the transformation coefficient of the frequency point, and calculating a second average transformation coefficient of a frequency band by first average transformation coefficients of all frequency points in the frequency band on the basis of initial frequency band division in a quantization matrix; and
4) obtaining a final weighted quantization coefficient by using the average luminance value of the image to be encoded and the second average transformation coefficient of every frequency band to correspondingly adjust an initial weighted quantization coefficient of every frequency band in the quantization matrix.

2. The method of claim 1, comprising:
calculating the average luminance value of the image to be encoded by the pixel luminance value of every pixel in the image to be encoded, further comprising:
calculating an image luminance value of the image to be encoded by the pixel luminance value of every pixel in the image to be encoded, and calculating the average luminance value of the image to be encoded by the image luminance value and pixel number of the image to be encoded; or
calculating a block luminance value of every block by pixel luminance values of all pixels in every block after dividing the image to be encoded into a plurality of blocks, and calculating the average luminance value of the image to be encoded by block luminance values of all blocks and number of blocks.

3. The method of claim 1, wherein the initial frequency band division is to divide a whole frequency domain into 6 frequency bands whose initial weighted quantization coefficients are {w₁, w₂, w₃, w₄, w₅, w₆}, wherein, w_{q} is the initial weighted quantization coefficient of a q^{th} frequency band, q∈{1, 2, 3, 4, 5, 6}, w₁<w₅<w₄<w₃<w₆<w₂, and the initial weighted quantization coefficients of the 6 frequency bands are {75, 225, 135, 120, 90, 150}.

4. The method of claim 2, wherein the initial frequency band division is to divide the whole frequency domain into 6 frequency bands whose initial weighted quantization coefficients are {w₁, w₂, w₃, w₄, w₅, w₆}, wherein, w_{q} is the initial weighted quantization coefficient of the q^{th} frequency band, q∈{1, 2, 3, 4, 5, 6}, w₁<w₅<w₄<w₃<w₆<w₂, and the initial weighted quantization coefficients of the 6 frequency bands are {75, 225, 135, 120, 90,150}.

5. The method of claim 1, comprising:
extracting the attribute component from the image to be encoded, dividing the attribute component into a plurality of attribute blocks, obtaining the transformation coefficient of every frequency point in the attribute block by transformation of the attribute block, and calculating the first average transformation coefficient of every frequency point in all attribute blocks to which the frequency point belongs by the transformation coefficient of the frequency point, further comprising:
extracting a luminance component from the image to be encoded, dividing the luminance component into a plurality of luminance blocks, obtaining a luminance transformation coefficient of each frequency point in a luminance block by transformation of the luminance block, and calculating an average luminance transformation coefficient of every frequency point in all luminance blocks to which the frequency point belongs as the first average transformation coefficient by the luminance transformation coefficient of the frequency point; or
extracting the luminance component and a chrominance component from the image to be encoded, dividing the luminance component into a plurality of luminance blocks, dividing the chrominance component into a plurality of chrominance blocks, obtaining the luminance transformation coefficient of each frequency point in the luminance block by transformation of the luminance block, obtaining a chrominance transformation coefficient of each frequency point in a chrominance block by transformation of the chrominance block, and calculating an average combined transformation coefficient of every frequency point in all luminance blocks and chrominance blocks to which the frequency point belongs as the first average transformation coefficient by the luminance transformation coefficient and the chrominance transformation coefficient of the frequency point.

6. The method of claim 3, comprising:
extracting the attribute component from the image to be encoded, dividing the attribute component into a plurality of attribute blocks, obtaining the transformation coefficient of every frequency point in the attribute block by transformation of the attribute block, and calculating the first average transformation coefficient of every frequency point in all attribute blocks to which the frequency point belongs by the transformation coefficient of the frequency point, further comprising:
extracting the luminance component from the image to be encoded, dividing the luminance component into a plurality of luminance blocks, obtaining the luminance transformation coefficient of each frequency point in the luminance block by transformation of the luminance block, and calculating the average luminance transformation coefficient of every frequency point in all luminance blocks to which the frequency point belongs as the first average transformation coefficient by the luminance transformation coefficient of the frequency point; or
extracting the luminance component and the chrominance component from the image to be encoded, dividing the luminance component into a plurality of luminance blocks, dividing the chrominance component into a plurality of chrominance blocks, obtaining the luminance transformation coefficient of each frequency point in the luminance block by transformation of the luminance block, obtaining the chrominance transformation coefficient of each frequency point in the chrominance block by transformation of the chrominance block, and calculating the average combined transformation coefficient of every frequency point in all luminance blocks and chrominance blocks to which the frequency point belongs as the first average transformation coefficient by the luminance transformation coefficient and the chrominance transformation coefficient of the frequency point.

7. The method of claim 4, comprising:
extracting the attribute component from the image to be encoded, dividing the attribute component into a plurality of attribute blocks, obtaining the transformation coefficient of every frequency point in the attribute block by transformation of the attribute block, and calculating the first average transformation coefficient of every frequency point in all attribute blocks to which the frequency point belongs by the transformation coefficient of the frequency point, further comprising:
extracting the luminance component from the image to be encoded, dividing the luminance component into a plurality of luminance blocks, obtaining the luminance transformation coefficient of each frequency point in the luminance block by transformation of the luminance block, and calculating the average luminance transformation coefficient of every frequency point in all luminance blocks to which the frequency point belongs as the first average transformation coefficient by the luminance transformation coefficient of the frequency point; or
extracting the luminance component and the chrominance component from the image to be encoded, dividing the luminance component into a plurality of luminance blocks, dividing the chrominance component into a plurality of chrominance blocks, obtaining the luminance transformation coefficient of each frequency point in the luminance block by transformation of the luminance block, obtaining the chrominance transformation coefficient of each frequency point in the chrominance block by transformation of the chrominance block, and calculating the average combined transformation coefficient of every frequency point in all luminance blocks and chrominance blocks to which the frequency point belongs as the first average transformation coefficient by the luminance transformation coefficient and the chrominance transformation coefficient of the frequency point.

8. The method of claim 1, comprising:
obtaining the final weighted quantization coefficient by using the average luminance value of the image to be encoded and the second average transformation coefficient of every frequency band to correspondingly adjust the initial weighted quantization coefficient of every frequency band in the quantization matrix, further comprising:
obtaining the final weighted quantization coefficient by finding a product of the average luminance value of the image to be encoded, the second average transformation coefficient of every frequency band and the initial weighted quantization coefficient of every frequency band; or
setting a first transformation relation of representing influence degree that the average luminance value of the image to be encoded has on a weighted quantization coefficient in the quantization matrix, and setting a second transformation relation for representing of the influence degree that the second average transformation coefficient of every frequency band has on the weighted quantization coefficient in the quantization matrix; obtaining a secondary average luminance value of the image to be encoded by using the first transformation relation to transform the average luminance value of the image to be encoded, and obtaining a secondary second average transformation coefficient of every frequency band by using the second transformation relation to transform the second average transformation coefficient of every frequency band; and obtaining the final weighted quantization coefficient by finding the product of the secondary average luminance value of the image to be encoded, the secondary second average transformation coefficient of every frequency band and the initial weighted quantization coefficient of every frequency band.

9. The method of claim 2, comprising:
obtaining the final weighted quantization coefficient by using the average luminance value of the image to be encoded and the second average transformation coefficient of every frequency band to correspondingly adjust the initial weighted quantization coefficient of every frequency band in the quantization matrix, further comprising:
obtaining the final weighted quantization coefficient by finding the product of the average luminance value of the image to be encoded, the second average transformation coefficient of every frequency band and the initial weighted quantization coefficient of every frequency band; or
setting the first transformation relation of representing the influence degree that the average luminance value of the image to be encoded has on the weighted quantization coefficient in the quantization matrix, and setting the second transformation relation for representing of the influence degree that the second average transformation coefficient of every frequency band has on the weighted quantization coefficient in the quantization matrix; obtaining the secondary average luminance value of the image to be encoded by using the first transformation relation to transform the average luminance value of the image to be encoded, and obtaining the secondary second average transformation coefficient of every frequency band by using the second transformation relation to transform the second average transformation coefficient of every frequency band; and obtaining the final weighted quantization coefficient by finding the product of the secondary average luminance value of the image to be encoded, the secondary second average transformation coefficient of every frequency band and the initial weighted quantization coefficient of every frequency band.

10. The method of claim 6, comprising:
obtaining the final weighted quantization coefficient by using the average luminance value of the image to be encoded and the second average transformation coefficient of every frequency band to correspondingly adjust the initial weighted quantization coefficient of every frequency band in the quantization matrix, further comprising:
obtaining the final weighted quantization coefficient by finding the product of the average luminance value of the image to be encoded, the second average transformation coefficient of every frequency band and the initial weighted quantization coefficient of every frequency band; or
setting the first transformation relation of representing the influence degree that the average luminance value of the image to be encoded has on the weighted quantization coefficient in the quantization matrix, and setting the second transformation relation for representing of the influence degree that the second average transformation coefficient of every frequency band has on the weighted quantization coefficient in the quantization matrix; obtaining the secondary average luminance value of the image to be encoded by using the first transformation relation to transform the average luminance value of the image to be encoded, and obtaining the secondary second average transformation coefficient of every frequency band by using the second transformation relation to transform the second average transformation coefficient of every frequency band; and obtaining the final weighted quantization coefficient by finding the product of the secondary average luminance value of the image to be encoded, the secondary second average transformation coefficient of every frequency band and the initial weighted quantization coefficient of every frequency band.

11. The method of claim 7, comprising:
obtaining the final weighted quantization coefficient by using the average luminance value of the image to be encoded and the second average transformation coefficient of every frequency band to correspondingly adjust the initial weighted quantization coefficient of every frequency band in the quantization matrix, further comprising:
obtaining the final weighted quantization coefficient by finding the product of the average luminance value of the image to be encoded, the second average transformation coefficient of every frequency band and the initial weighted quantization coefficient of every frequency band; or
setting the first transformation relation of representing the influence degree that the average luminance value of the image to be encoded has on the weighted quantization coefficient in the quantization matrix, and setting the second transformation relation for representing of the influence degree that the second average transformation coefficient of every frequency band has on the weighted quantization coefficient in the quantization matrix; obtaining the secondary average luminance value of the image to be encoded by using the first transformation relation to transform the average luminance value of the image to be encoded, and obtaining the secondary second average transformation coefficient of every frequency band by using the second transformation relation to transform the second average transformation coefficient of every frequency band; and obtaining the final weighted quantization coefficient by finding the product of the secondary average luminance value of the image to be encoded, the secondary second average transformation coefficient of every frequency band and the initial weighted quantization coefficient of every frequency band.

12. An AVS video encoder, comprising:
a) an obtaining module, for obtaining an image to be encoded;
b) a luminance value calculation module, for calculating an average luminance value of the image to be encoded by a first luminance value of every pixel in the image to be encoded;
c) a division module, for extracting an attribute component from the image to be encoded and dividing the attribute component into a plurality of attribute blocks;
d) a transformation module, for transforming the attribute blocks to obtain a transformation coefficient of every frequency point in an attribute block;
e) an average transformation coefficient calculation module, for calculating a first average transformation coefficient of every frequency point in all attribute blocks to which the frequency point belongs by transformation coefficients of frequency points and calculating a second average transformation efficient of a frequency band by the first average transformation coefficients of all frequency points in the frequency band on the basis of initial frequency band division in a quantization matrix; and
f) an adjustment module, for using the average luminance value of the image to be encoded and a second average transformation coefficient of every frequency band to correspondently adjust an initial weighted quantization coefficient of every frequency band in the quantization matrix to obtain a final weighted quantization coefficient.

13. The encoder of claim 12, comprising:
the luminance value calculation module, comprising:
an image luminance value calculation unit, for calculating an image luminance value of the image to be encoded by a pixel luminance value of every pixel in the image to be encoded, and
a first average luminance value calculation unit, for calculating the average luminance value of the image to be encoded by the image luminance value and pixel number of the image to be encoded; or
the luminance value calculation module, comprising:
a block luminance value calculation unit, for calculating a block luminance value of every block by pixel luminance values of all pixels in every block after the division module dividing the image to be encoded into a plurality of blocks, and
a second average luminance value calculation unit, for calculating the average luminance value of the image to be encoded by the block luminance values of all blocks and the number of blocks.

14. The encoder of claim 12, wherein the initial frequency band division is to divide a whole frequency domain into 6 frequency bands whose initial weighted quantization coefficients are {w₁, w₂, w₃, w₄, w₅, w₆}, wherein, w_{q} is the initial weighted quantization coefficient of a q^{th} frequency band, q∈{1, 2, 3, 4, 5, 6}, w₁<w₅<w₄<w₃<w₆<w₂, and the initial weighted quantization coefficients of the 6 frequency bands are {75, 225, 135, 120, 90, 150}.

15. The encoder of claim 13, wherein the initial frequency band division is to divide the whole frequency domain into 6 frequency bands whose initial weighted quantization coefficients are {w₁, w₂, w₃, w₄, w₅, w₆}, wherein, w_{q} is the initial weighted quantization coefficient of the q^{th} frequency band, q∈{1, 2, 3, 4, 5, 6}, w₁<w₅<w₄<w₃<w₆<w₂, and the initial weighted quantization coefficients of the 6 frequency bands are {75, 225, 135, 120, 90, 150}.

16. The encoder of claim 12, wherein:
the attribute component is a luminance component, the attribute block is a luminance block, the transformation module is used for transforming luminance blocks to obtain a luminance transformation coefficient of every frequency point in the luminance block, and the average transformation coefficient calculation module is used for calculating an average luminance transformation coefficient of every frequency point in all luminance sub-blocks to which the frequency point belongs as the first average transformation coefficient by the luminance transformation coefficient of the frequency point; or
attribute components comprise the luminance component and a chrominance component, the attribute blocks comprise the luminance blocks and chrominance blocks, the transformation module is used to obtain the luminance transformation coefficient of each frequency point in the luminance block by transformation of the luminance block and to obtain a chrominance transformation coefficient of each frequency point in a chrominance block by transformation of the chrominance block, and the average transformation coefficient calculation module is used to calculate an average combined transformation coefficient of every frequency point in all luminance blocks and chrominance blocks to which the frequency point belongs as the first average transformation coefficient by the luminance transformation coefficient and the chrominance transformation coefficient of the frequency point.

17. The encoder of claim 15, wherein:
the attribute component is the luminance component, the attribute block is the luminance block, the transformation module is used for transforming the luminance blocks to obtain the luminance transformation coefficient of every frequency point in the luminance block, and the average transformation coefficient calculation module is used for calculating the average luminance transformation coefficient of every frequency point in all luminance sub-blocks to which the frequency point belongs as the first average transformation coefficient by the luminance transformation coefficient of the frequency point; or
the attribute components comprise the luminance component and the chrominance component, the attribute blocks comprise the luminance blocks and the chrominance blocks, the transformation module is used to obtain the luminance transformation coefficient of each frequency point in the luminance block by transformation of the luminance block and to obtain the chrominance transformation coefficient of each frequency point in the chrominance block by transformation of the chrominance block, and the average transformation coefficient calculation module is used to calculate the average combined transformation coefficient of every frequency point in all luminance blocks and chrominance blocks to which the frequency point belongs as the first average transformation coefficient by the luminance transformation coefficient and the chrominance transformation coefficient of the frequency point.

18. The encoder of claim 12, comprising:
the adjustment module, comprising:
a call unit, for obtaining the initial weighted quantization coefficient of every frequency band in the quantization matrix, and
a first product calculation unit, for obtaining the final weighted quantization coefficient by finding a product of the average luminance value of the image to be encoded, the second average transformation coefficient of every frequency band and the initial weighted quantization coefficient of every frequency band; or
the adjustment module, comprising:
the call unit, for obtaining the initial weighted quantization coefficient of every frequency band in the quantization matrix,
a transformation unit, for transforming the average luminance value of the image to be encoded by using a first transformation relation to obtain a secondary average luminance value of the image to be encoded and for transforming the second average transformation coefficient of every frequency band by using a second transformation relation to obtain a secondary second average transformation coefficient of every frequency band, according to a preset first transformation relation used for representing influence degree that the average luminance value of the image to be encoded has on a weighted quantization coefficient in the quantization matrix and a preset second transformation relation used for representing the influence degree that the second average transformation coefficient of every frequency band has on the weighted quantization coefficient in the quantization matrix, and
a second product calculation unit, for obtaining the final weighted quantization coefficient by finding the product of the secondary average luminance value of the image to be encoded, the secondary second average transformation coefficient of every frequency band and the initial weighted quantization coefficient of every frequency band.

19. The encoder of claim 15, comprising:
the adjustment module, comprising:
the call unit, for obtaining the initial weighted quantization coefficient of every frequency band in the quantization matrix, and
the first product calculation unit, for obtaining the final weighted quantization coefficient by finding the product of the average luminance value of the image to be encoded, the second average transformation coefficient of every frequency band and the initial weighted quantization coefficient of every frequency band; or
the adjustment module, comprising:
the call unit, for obtaining the initial weighted quantization coefficient of every frequency band in the quantization matrix,
the transformation unit, for transforming the average luminance value of the image to be encoded by using the first transformation relation to obtain the secondary average luminance value of the image to be encoded and for transforming the second average transformation coefficient of every frequency band by using the second transformation relation to obtain the secondary second average transformation coefficient of every frequency band, according to the preset first transformation relation used for representing the influence degree that the average luminance value of the image to be encoded has on the weighted quantization coefficient in the quantization matrix and the preset second transformation relation used for representing the influence degree that the second average transformation coefficient of every frequency band has on the weighted quantization coefficient in the quantization matrix, and
the second product calculation unit, for obtaining the final weighted quantization coefficient by finding the product of the secondary average luminance value of the image to be encoded, the secondary second average transformation coefficient of every frequency band and the initial weighted quantization coefficient of every frequency band.

20. The encoder of claim 17, comprising:
the adjustment module, comprising:
the call unit, for obtaining the initial weighted quantization coefficient of every frequency band in the quantization matrix, and
the first product calculation unit, for obtaining the final weighted quantization coefficient by finding the product of the average luminance value of the image to be encoded, the second average transformation coefficient of every frequency band and the initial weighted quantization coefficient of every frequency band; or
the adjustment module, comprising:
the call unit, for obtaining the initial weighted quantization coefficient of every frequency band in the quantization matrix,
the transformation unit, for transforming the average luminance value of the image to be encoded by using the first transformation relation to obtain the secondary average luminance value of the image to be encoded and for transforming the second average transformation coefficient of every frequency band by using the second transformation relation to obtain the secondary second average transformation coefficient of every frequency band, according to the preset first transformation relation used for representing the influence degree that the average luminance value of the image to be encoded has on the weighted quantization coefficient in the quantization matrix and the preset second transformation relation used for representing the influence degree that the second average transformation coefficient of every frequency band has on the weighted quantization coefficient in the quantization matrix, and
the second product calculation unit, for obtaining the final weighted quantization coefficient by finding the product of the secondary average luminance value of the image to be encoded, the secondary second average transformation coefficient of every frequency band and the initial weighted quantization coefficient of every frequency band.
